(19) United States
(12) Patent Application Publication
(10) Pub. No.: US 2018/0355231 A1
(43) Pub. Date: Dec. 13, 2018

(54) DEBONDABLE ADHESIVES AND THE HIGH TEMPERATURE USE THEREOF

(71) Applicant: HENKEL IP & HOLDING GMBH, Duesseldorf (DE)

(72) Inventors: Alan E. LITKE, Waterbury, CT (US); Bahram ISSARI, Glastonbury, CT (US); Laxmisha SRIDHAR, Monmouth Junction, NJ (US)

(21) Appl. No.: 16/053,920

(22) Filed: Aug. 3, 2018

Related U.S. Application Data
(63) Continuation of application No. PCT/US2017/016422, filed on Feb. 3, 2017.
(60) Provisional application No. 62/291,181, filed on Feb. 4, 2016.

(51) Int. Cl. C09J 179/08; C09J 5/06; C09J 4/00; B32B 37/12; B32B 43/00; B32B 38/00

(52) U.S. Cl. CPC C09J 179/08; C09J 5/06; C09J 4/00; B32B 37/1207; B32B 43/006; B32B 2038/0076; C09J 2205/302; C09J 2205/31; C09J 2433/00; C09J 2479/08; B32B 38/0036

(57) ABSTRACT

Provided herein are debondable adhesive compositions comprising (A) one or more bis-maleimide (BMI), nadimide or itaconimide oligomer(s), (B) at least one ethylenically unsaturated co-monomer (e.g. co-monomers selected from the group consisting of acrylates, methacrylates, vinyl ethers, vinyl esters, styrenic compounds, allyl compounds, polybutadienes, cinnamates, crotonates, and mixtures of any two or more thereof), and (C) a photoinitiator. In another embodiment, the present invention is directed to an assembly of a substrate and a carrier for the substrate in which the debondable adhesive composition temporarily bonds the substrates, and a method for fabricating the assembly. The debondable adhesive compositions maintain their adhesion at temperatures of 300° C. or greater, are easily and cleanly debondable at ambient conditions, permit temporary bonding at high processing conditions, and do not compromise handling or performance of the substrates.

### BACKGROUND

### Field

The present invention relates to curable temporary adhesives and methods for the use thereof in high temperature applications. In one aspect, the invention relates to methods for the temporary attachment of one substrate to another. In another aspect, the invention relates to methods for debonding a substrate and a carrier. In yet another aspect, the invention relates to methods for the permanent attachment of one substrate to another. In certain aspects, the invention relates to assemblies comprising a first article temporarily adhered to a second article by a cured aliquot of a formulation as described herein. In certain embodiments, the invention relates to assemblies comprising a first article permanently adhered to a second article by a cured aliquot of a formulation as described herein.

### Brief Description of Related Technology

Within a number of industries, there is growing interest in the use of flexible and/or very thin substrates, for example, stainless steel, silicon wafers, glass, ceramic, polyimide and polyester films. Flexible and very thin substrates tend to be too fragile to be handled freestanding in downstream manufacturing conditions, and must be supported on a suitable carrier to survive. After the fabrication processes are done, the substrate must be removable from the carrier in substantially undamaged condition, preferably at ambient temperature.

In the electronics industry, as one example, imaging displays, sensors, photovoltaics, RFIDs, and the like, increasingly require thin and/or flexible substrates for display applications for cell phones, personal digital assistants, iPADs, TVs, and the like. An exemplary substrate is a very thin (100 μm) glass packed with functionalities. The glass is typically processed at temperatures as high as 400° C. to depose thin film transistors (TFT) or at 350° C. to deposit indium tin oxide (ITO) as a transparent conductor. Due to the fragility of the glass and the harsh process conditions, this glass must be reinforced or protected by a more stable substrate during fabrication.

Uses such as this call for adhesives that meet a plurality of the following criteria:
are stable at high temperature,
are easily and cleanly debondable,
permit temporary bonding at high processing temperatures, and/or
do not compromise handling or performance of the substrates.

Development of such adhesives would allow existing fabrication methods, such as methods used for the preparation of semiconductors, active matrix thin film transistors, touch membranes, photovoltaics, and the like, to use the currently installed base of manufacturing tools and machines. Most currently available temporary adhesives are not thermally stable at the maximum processing of the manufacturing steps, which can be as high as 400° C.

Adhesives suitable for high temperature temporary bonding applications, which can later be removed at room temperature without causing damage to the target component, would advance the use of thinner or more flexible substrates across various industries.

### SUMMARY

In accordance with the present invention, there are provided debondable adhesive compositions comprising:

(A) one or more bis-maleimide (BMI), nadimide or itaconimide oligomer(s),

(B) at least one ethylenically unsaturated co-monomer (e.g. co-monomers selected from the group consisting of acrylates, methacrylates, vinyl ethers, vinyl esters, styrenic compounds, allyl compounds, polybutadienes, cinnamates, crotonates, and, mixtures of any two or more thereof), and

(C) a photoinitiator.

The resulting adhesive compositions maintain adhesion at temperatures of 300° C., or greater, are mechanically debondable (peelable) at room temperature after exposure to heat cycling, and the residue thereof is easily removed by common solvents. The adhesive compositions of the present invention have high adhesion to target substrates; moreover, adhesion promoters may optionally be employed for further control of bond strength. The formulations are capable of being light cured without radical initiator, but typical photoinitiators may optionally be added depending on the reactivity required.

In another embodiment, the present invention provides assemblies comprising a substrate and a carrier for the substrate (see, for example, FIG. 1) in which the debondable adhesive composition is disposed between the substrates and temporarily bonds the substrates, and a method for fabricating the assembly.

In a further embodiment, the present invention provides methods of debonding a substrate from a carrier comprising: (a) disposing a debondable adhesive on a substrate and/or a carrier, (b) contacting the substrate and carrier so that the debondable adhesive is disposed between, forming an assembly, (c) heating the assembly at a temperature or range of temperatures to adhere the substrates, or (d) exposing the assembly to radiation to adhere the substrates, or (e) exposing the assembly to radiation followed by thermal heating to adhere the substrates, and (f) allowing the assembly to come to ambient temperature and mechanically separating the substrates.

When step (c) is used, heating will be applied at a temperature or range of temperatures within the temperature range of 60° C. to 200° C. for 1 to 60 minutes. In some embodiments, the temperature or range of temperatures may fall within the temperature range of 80° C. to 175° C. for 1 to 45 minutes; in some embodiments, the temperature or range of temperatures may fall within the temperature range of 100° C. to 150° C. for 1 to 30 minutes.

When step (d) is used, UV radiation can be applied using a 400 Watt lamp for about 10 seconds to 5 minutes; in some embodiments, UV radiation can be applied for 30 seconds to 4 minutes; in some embodiments, UV radiation can be applied for 1 to 3 minutes; other sources of radiation may also be used within the discretion of the practitioner.

When step (e) is used, a combination of the parameters for steps (c) and (d) will be used to obtain the desired cure; suitable cure conditions can be determined by one skilled in the art without undue experimentation knowing the parameters of steps (c) and (d).

Suitable debondable adhesive compositions maintain their adhesion at temperatures of 300° C. or greater, are easily and cleanly debondable at ambient conditions, permit temporary bonding at high temperature processing conditions, and do not compromise handling or performance of the substrates. In some embodiments, the adhesive compositions maintain the adhesion thereof at temperatures of 300° C. or greater, e.g., up to 440° C., and are mechanically debondable at room temperature at a force 5N/25 mm or less, in some embodiments at a force of 3N/25 mm or less, and in some embodiments at a force of 2N/25 mm or less.

In certain aspects, there are provided assemblies comprising a first article temporarily or permanently adhered to a second article by a cured aliquot of a formulation as described herein (see, for example, FIG. 1).

### BRIEF DESCRIPTION OF THE FIGURE

FIG. 1 illustrates an exemplary article prepared according to the methods of the present invention, where glass carrier 110 has applied thereto about 150 μm slit coating 101, which in turn, has applied thereto one or more glass elements 109, which in turn, has applied thereto edge protection 102 or 108 and/or surface feature protection 103, 105 and 107, wherein glass elements 109 are typically spaced by about 5-8 mm (see 104).

### DETAILED DESCRIPTION

In accordance with the present invention, there are provided methods of making a debondable assembly, the methods comprising:
forming an assembly by bringing a substrate and a carrier in contact with one another, separated only by an aliquot of debondable adhesive composition; and thereafter
curing the resulting assembly under conditions suitable to promote adhesion therebetween,
   where the substrate is a fragile material;
   where the carrier imparts structural integrity to the substrate upon bonding thereto;
   where the debondable adhesive composition comprises:
in the range of about 10 up to 95 wt % of one or more BMI, nadimide or itaconimide oligomer(s);
in the range of about 5 up to 90 wt % of at least one ethylenically unsaturated co-monomer;
optionally a reactive organic diluent, which, when present, is present in the range of about 1 up to 50 wt %;
optionally a non-reactive organic diluent, which, when present, is present in the range of about 5 up to 40 wt %; and
optionally a photoinitiator;
   where the composition is further characterized by one or more of the following:
the composition is stable to a temperature of at least 200° C.,
the composition is chemically resistant to acids, bases and solvents,
the composition undergoes low level of shrinkage upon curing thereof,
the composition has high adhesion to suitable substrates, especially at elevated temperatures,
the composition is heat and/or light curable, and
the composition is debondable at or about room temperature.

As used within this specification and the claims, “substrate” refers to the target component for the fabrication processes, and “carrier” refers to the support structure for the “substrate”.

The adhesive of this invention has been developed to provide adequate temporary adhesion of substrates to carriers at fabrication temperatures ranging from 300° C. up to 450° C., and to debond with adhesive failure at the interface of the substrate and carrier at ambient temperature without damaging the substrate.

Maleimides, nadimides or itaconimides contemplated for use herein are compounds having the structure:

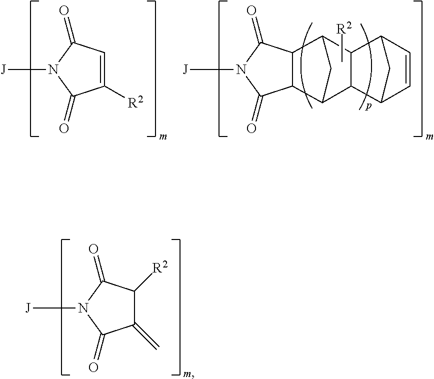

respectively, where:
m is 1-15,
p is 0-15,
each R² is independently selected from hydrogen or lower alkyl (such as C₁₋₅), and
J is a monovalent or a polyvalent radical comprising organic or organosiloxane radicals, and
combinations of two or more thereof.

In some embodiments of the present invention, J is a monovalent or polyvalent radical selected from:
hydrocarbyl or substituted hydrocarbyl species typically having in the range of about 6 up to about 500 carbon atoms, where the hydrocarbyl species is selected from alkyl, alkenyl, alkynyl, cycloalkyl, cycloalkenyl, aryl, alkylaryl, arylalkyl, aryalkenyl, alkenylaryl, arylalkynyl or alkynylaryl;
hydrocarbylene or substituted hydrocarbylene species typically having in the range of about 6 up to about 500 carbon atoms, where the hydrocarbylene species are selected from alkylene, alkenylene, alkynylene, cycloalkylene, cycloalkenylene, arylene, alkylarylene, arylalkylene, arylalkenylene, alkenylarylene, arylalkynylene or alkynylarylene,
heterocyclic or substituted heterocyclic species typically having in the range of about 6 up to about 500 carbon atoms,
polysiloxane, or
polysiloxane-polyurethane block copolymers, as well as combinations of one or more of the above with a linker selected from covalent bond, —O—, —S—, —NR—, —NR—C(O)—, —NR—C(O)—O—, —NR—C(O)—NR—, —S—C(O)—, —S—C(O)—O—, —S—C(O)—NR—, —O—S(O)₂—, —O—S(O)₂—O—, —O—S(O)₂—NR—, —O—S(O)—, —O—S(O)—O—, —O—S(O)—NR—, —O—NR—C(O)—, —O—NR—C(O)—O—, —O—NR—C(O)—NR—, —NR—O—C(O)—, —NR—O—C(O)—O—, —NR—O—C(O)—NR—, —O—NR—C(S)—, —O—NR—C(S)—O—, —O—NR—C(S)—NR—, —NR—O—C(S)—, —NR—O—C(S)—O—, —NR—O—C(S)—NR—, —O—C(S)—, —O—C(S)—O—, —O—C(S)—NR—, —NR—C(S)—, —NR—C(S)—O—, —NR—C(S)—NR—, —S—S(O)₂—, —S—S(O)₂O—, —S—S(O)₂—NR—, —NR—O—S(O)—, —NR—O—S(O)—O—, —NR—O—S(O)—NR—, —NR—O—S(O)₂—, —NR—O—S(O)₂—O—, —NR—O—S(O)₂—NR—, —O—NR—S(O)—, —O—NR—S(O)—O—, —O—NR—S(O)—NR—, —O—NR—S(O)₂—O—, —O—NR—S(O)₂—NR—, —O—NR—S(O)₂—, —O—P(O)R₂—, —S—P(O)R₂—, or —NR—P(O)R₂—; where each R is independently hydrogen, alkyl or substituted alkyl.

Exemplary compositions include those where J is oxyalkyl, thioalkyl, aminoalkyl, carboxylalkyl, oxyalkenyl, thioalkenyl, aminoalkenyl, carboxyalkenyl, oxyalkynyl, thioalkynyl, aminoalkynyl, carboxyalkynyl, oxycycloalkyl, thiocycloalkyl, aminocycloalkyl, carboxycycloalkyl, oxycloalkenyl, thiocycloalkenyl, aminocycloalkenyl, carboxycycloalkenyl, heterocyclic, oxyheterocyclic, thioheterocyclic, aminoheterocyclic, carboxyheterocyclic, oxyaryl, thioaryl, aminoaryl, carboxyaryl, heteroaryl, oxyheteroaryl, thioheteroaryl, aminoheteroaryl, carboxyheteroaryl, oxyalkylaryl, thioalkylaryl, aminoalkylaryl, carboxyalkylaryl, oxyarylalkyl, thioarylalkyl, aminoarylalkyl, carboxyarylalkyl, oxyarylalkenyl, thioarylalkenyl, aminoarylalkenyl, carboxyarylalkenyl, oxyalkenylaryl, thioalkenylaryl, aminoalkenylaryl, carboxyalkenylaryl, oxyarylalkynyl, thioarylalkynyl, aminoarylalkynyl, carboxyarylalkynyl, oxyalkynylaryl, thioalkynylaryl, aminoalkynylaryl or carboxyalkynylaryl, oxyalkylene, thioalkylene, aminoalkylene, carboxyalkylene, oxyalkenylene, thioalkenylene, aminoalkenylene, carboxyalkenylene, oxyalkynylene, thioalkynylene, aminoalkynylene, carboxyalkynylene, oxycycloalkylene, thiocycloalkylene, aminocycloalkylene, carboxycycloalkylene, oxycycloalkenylene, thiocycloalkenylene, aminocycloalkenylene, carboxycycloalkenylene, oxyarylene, thioarylene, aminoarylene, carboxyarylene, oxyalkylarylene, thioalkylarylene, aminoalkylarylene, carboxyalkylarylene, oxyarylalkylene, thioarylalkylene, aminoarylalkylene, carboxyarylalkylene, oxyarylalkenylene, thioarylalkenylene, aminoarylalkenylene, carboxyarylalkenylene, oxyalkenylarylene, thioalkenylarylene, amino alkenylarylene, carboxyalkenylarylene, oxyarylalkynylene, thioarylalkynylene, aminoarylalkynylene, carboxy arylalkynylene, oxyalkynylarylene, thioalkynylarylene, amino alkynylarylene, carboxyalkynylarylene, heteroarylene, oxyheteroarylene, thioheteroarylene, aminoheteroarylene, carboxyheteroarylene, heteroatom-containing di- or polyvalent cyclic moiety, oxyheteroatom-containing di- or polyvalent cyclic moiety, thioheteroatom-containing di- or polyvalent cyclic moiety, aminoheteroatom-containing di- or polyvalent cyclic moiety, or a carboxyheteroatom-containing di- or polyvalent cyclic moiety.

Exemplary maleimides, nadimides or itaconimides contemplated for use herein include:

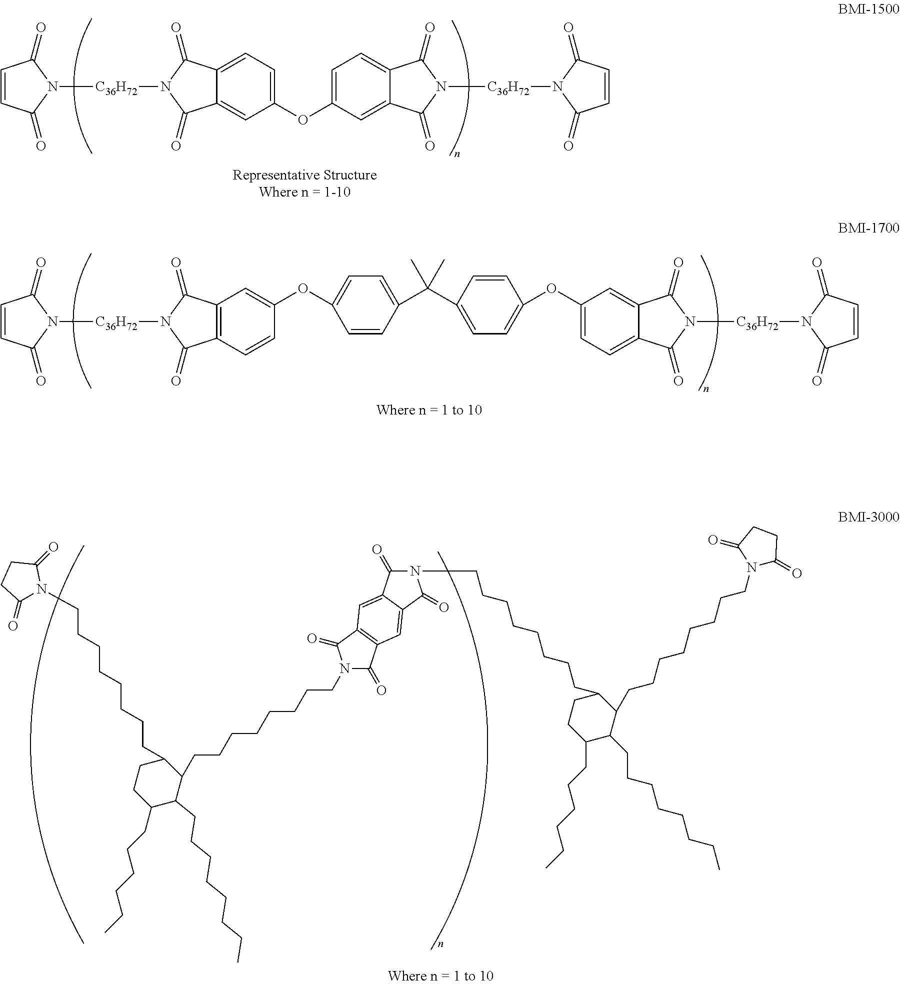

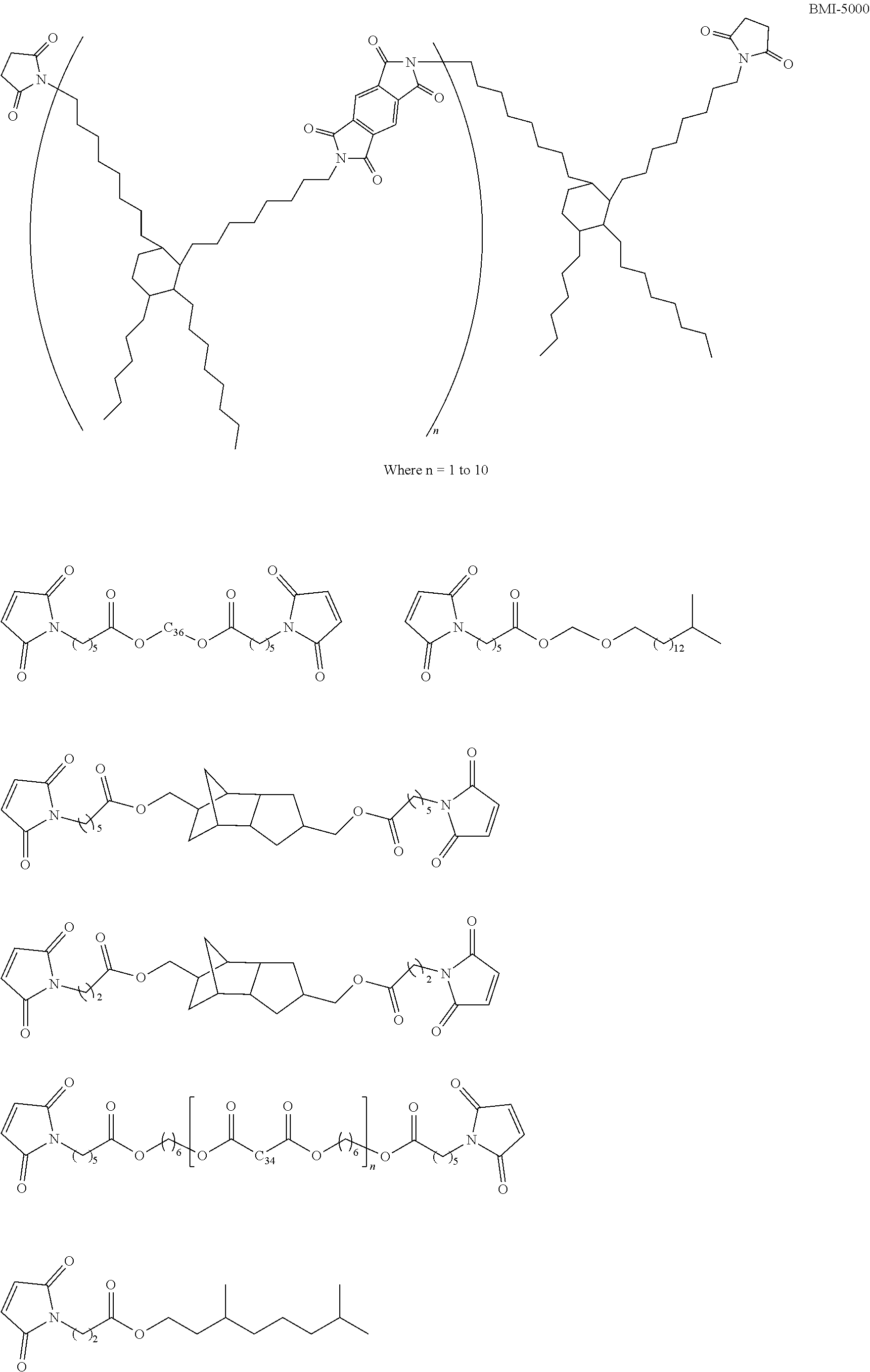

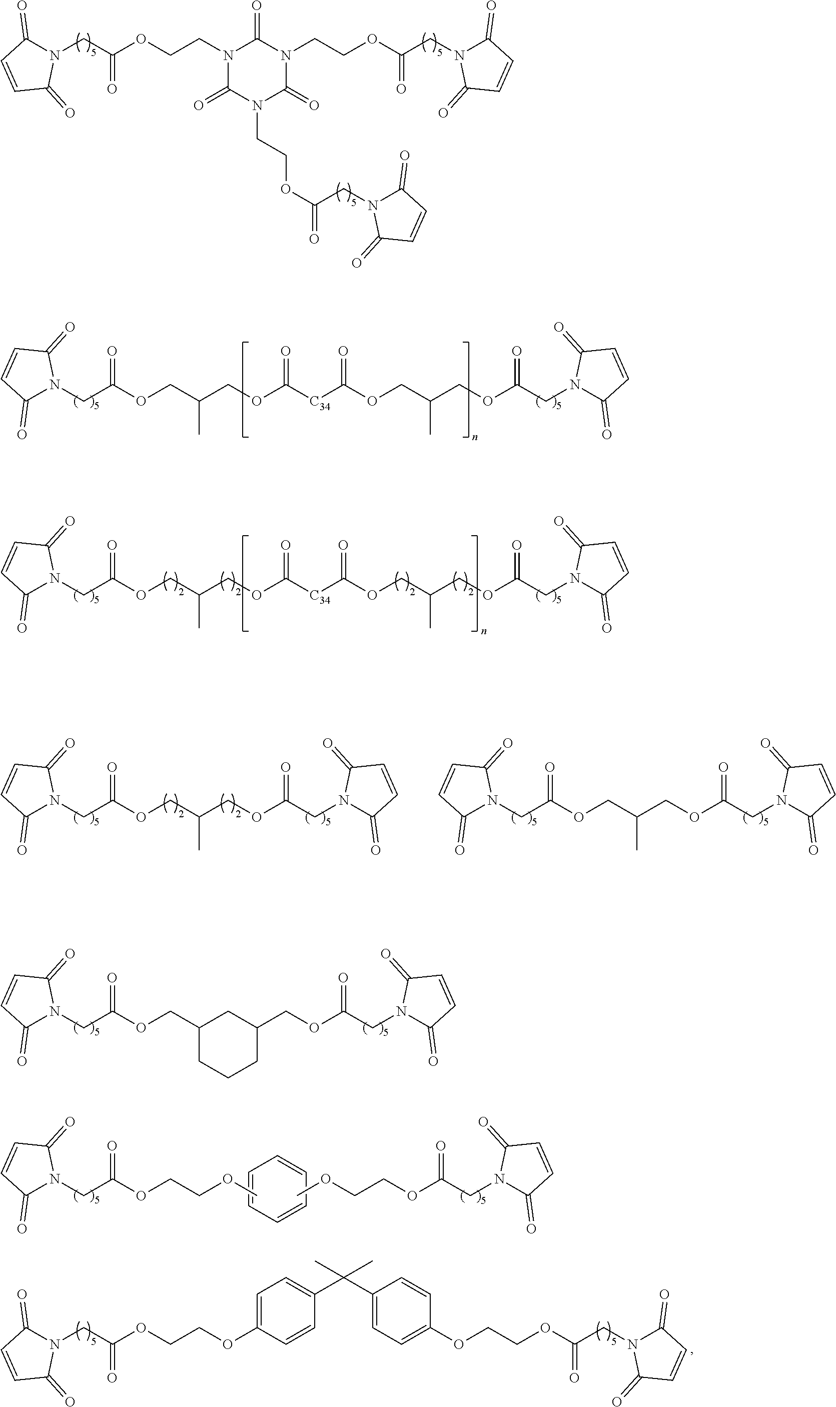

as well as mixtures of any two or more thereof.

In some embodiments, the maleimide, nadimide or itaconimide is an imide-extended, low molecular weight bis-maleimide BMI oligomer having the structure:

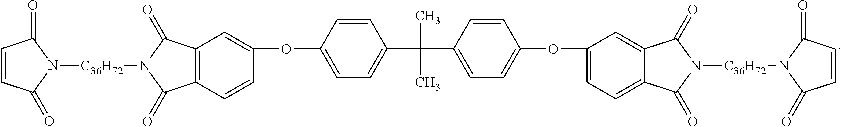

In certain embodiments, compositions employed in the practice of the present invention comprise:
at least 20 wt % of the BMI, nadimide or itaconimide oligomer,
no greater than 80 wt % of the at least one ethylenically unsaturated co-monomer, and
at least 1 wt % of the photoinitiator.

In certain embodiments, compositions employed in the practice of the present invention comprise:
at least 30 wt % of the BMI, nadimide or itaconimide oligomer,
no greater than 70 wt % of the at least one ethylenically unsaturated co-monomer, and
at least 1 wt % of the photoinitiator.

In certain embodiments, compositions employed in the practice of the present invention comprise:
at least 40 wt % of the BMI, nadimide or itaconimide oligomer,
no greater than 60 wt % of the at least one ethylenically unsaturated co-monomer, and
at least 1 wt % of the photoinitiator.

In certain embodiments, compositions employed in the practice of the present invention comprise:
at least 50 wt % of the BMI, nadimide or itaconimide oligomer,
no greater than 50 wt % of the at least one ethylenically unsaturated co-monomer, and
at least 1 wt % of the photoinitiator.

In certain embodiments, compositions employed in the practice of the present invention comprise:
at least 60 wt % of the BMI, nadimide or itaconimide oligomer,
no greater than 40 wt % of the at least one ethylenically unsaturated co-monomer, and
at least 1 wt % of the photoinitiator.

In certain embodiments, compositions employed in the practice of the present invention comprise:
at least 70 wt % of the BMI, nadimide or itaconimide oligomer,
no greater than 30 wt % of the at least one ethylenically unsaturated co-monomer, and
at least 1 wt % of the photoinitiator.

In certain embodiments, compositions employed in the practice of the present invention comprise:
at least 80 wt % of the BMI, nadimide or itaconimide oligomer,
no greater than 20 wt % of the at least one ethylenically unsaturated co-monomer, and
at least 1 wt % of the photoinitiator.

In certain embodiments, compositions employed in the practice of the present invention comprise:
at least 90 wt % of the BMI, nadimide or itaconimide oligomer,
no greater than 10 wt % of the at least one ethylenically unsaturated co-monomer, and
at least 1 wt % of the photoinitiator.

In certain embodiments, compositions employed in the practice of the present invention comprise:
at least 95 wt % of the BMI, nadimide or itaconimide oligomer,
no greater than 5 wt % of the at least one ethylenically unsaturated co-monomer, and
at least 1 wt % of the photoinitiator.

Ethylenically unsaturated co-monomers contemplated for use herein include (meth)acrylates, vinyl ethers, vinyl esters, styrenic compounds, allyl compounds, monofunctional maleimides, polybutadienes, cinnamates, crotonates, and the like, as well as mixtures of any two or more thereof.

(Meth)acrylates contemplated for use herein include monofunctional (meth)acrylates, difunctional (meth)acrylates, trifunctional (meth)acrylates, polyfunctional (meth)acrylates, and the like, as well as mixtures of any two or more thereof.

Exemplary monofunctional (meth)acrylates include phenylphenol acrylate, methoxypolyethylene acrylate, acryloyloxyethyl succinate, fatty acid acrylate, methacryloyloxyethylphthalic acid, phenoxyethylene glycol methacrylate, fatty acid methacrylate, β-carboxyethyl acrylate, isobornyl acrylate, isobutyl acrylate, t-butyl acrylate, hydroxyethyl acrylate, hydroxypropyl acrylate, dihydrocyclopentadiethyl acrylate, cyclohexyl methacrylate, tricyclodecane acrylate, t-butyl methacrylate, dimethylaminoethyl methacrylate, diethylaminoethyl methacrylate, t-butylaminoethyl methacrylate, 4-hydroxybutyl acrylate, tetrahydrofurfuryl acrylate, benzyl acrylate, ethylcarbitol acrylate, phenoxyethyl acrylate, methoxytriethylene glycol acrylate, monopentaerythritol acrylate, dipentaerythritol acrylate, tripentaerythritol acrylate, polypentaerythritol acrylate, and the like.

Exemplary difunctional (meth)acrylates include hexanediol dimethacrylate, hydroxyacryloyloxypropyl methacrylate, hexanediol diacrylate, urethane acrylate, epoxyacrylate, bisphenol A-type epoxyacrylate, modified epoxyacrylate, fatty acid-modified epoxyacrylate, amine-modified bisphenol A-type epoxyacrylate, allyl methacrylate, ethylene glycol dimethacrylate, diethylene glycol dimethacrylate, ethoxylated bisphenol A dimethacrylate, tricyclodecanedimethanol dimethacrylate, glycerin dimethacrylate, polypropylene glycol diacrylate, propoxylated ethoxylated bisphenol A diacrylate, 9,9-bis(4-(2-acryloyloxyethoxy)phenyl) fluorene, tricyclodecane diacrylate, dipropylene glycol diacrylate, polypropylene glycol diacrylate, PO-modified neopentyl glycol diacrylate, tricyclodecanedimethanol diacrylate, 1,12-dodecanediol dimethacrylate, and the like.

Exemplary trifunctional (meth)acrylates include trimethylolpropane trimethacrylate, trimethylolpropane triacrylate, trimethylolpropane ethoxy triacrylate, polyether triacrylate, glycerin propoxy triacrylate, and the like.

Exemplary polyfunctional (meth)acrylates include dipentaerythritol polyacrylate, dipentaerythritol hexaacrylate, pentaerythritol tetraacrylate, pentaerythritolethoxy tetraacrylate, ditrimethylolpropane tetraacrylate, and the like.

Additional exemplary acrylates contemplated for use in the practice of the present invention include those described in U.S. Pat. No. 5,717,034, the entire contents of which are hereby incorporated by reference herein.

Vinyl ethers contemplated for use herein include compounds having the structure:

CH₂═CH—OR

where R is alkyl, substituted alkyl, alkenyl, substituted alkenyl, aryl, or substituted aryl.

Suitable commercially available vinyl ether resins include cyclohexane-dimethanol divinylether, dodecylvinylether, cyclohexyl vinylether, 2-ethylhexyl vinylether, dipropyleneglycol divinylether, hexanediol divinylether, octadecylvinylether, and butandiol divinylether, available from International Specialty Products (ISP); vinyl ethers sold under the tradenames VECTONMR 4010, 4020, 4030, 4040, 4051, 4210, 4220, 4230, 4060, 5015 available from Sigma-Aldrich, Inc., and the like.

Vinyl esters contemplated for use herein include compounds having the structure:

CH₂═CH—O—C(O)—R′

or

CH₂═CH—C(O)—O—R′

where R′ is alkyl or substituted alkyl.

Styrenic compounds contemplated for use herein include compounds having the structure:

Ph-CH═CH₂

where Ph is phenyl or substituted phenyl.

Suitable styrenic resins include, for example, those commercially available styrene, substituted styrenics, divinyl benzene, diphenylethylene, and any other resins possessing styrenic functionality. Such resins can be, for example, polyesters, carbamates, ureas, and the like.

Allyl compounds contemplated for use herein include compounds having the structure:

CH₂═CH—CH₂—X

where X is alkyl, substituted alkyl, aryl, substituted aryl, oxyalkyl, oxyaryl, NH-alkyl, N(alkyl)₂, NH-aryl, N(aryl)₂, thioalkyl, thioaryl, or N-substituted amide.

Suitable allyl ethers include those commercially available such as bisphenol A diallyl ether, bisphenol F diallyl ether, diallyl ether, diallyl carbonate, diallyl ethers derived from aliphatic polyols, and diallyl sulfide.

Optionally, one or more additional monomers (also referred to herein as reactive diluents) or resins derived therefrom may be present in invention formulations, such as, for example, thiols, cyanate esters, oxetanes, polyesters, polyurethanes, polyimides, melamines, urea-formaldehydes, phenol-formaldehydes, and the like. When present, such materials may be present in the range of about 0.1 up to about 60 wt % based on the total weight of the final formulation.

When present, cyanate ester monomers contemplated for use in the practice of the present invention contain two or more ring forming cyanate (—O—C≡N) groups which cyclotrimerize to form substituted triazine rings upon heating. Because no leaving groups or volatile byproducts are formed during curing of the cyanate ester monomer, the curing reaction is referred to as addition polymerization. Suitable polycyanate ester monomers that may be used in the practice of the present invention include, for example, 1,1-bis(4-cyanatophenyl)methane, 1,1-bis(4-cyanatophenyl)ethane, 2,2-bis(4-cyanatophenyl)propane, bis(4-cyanatophenyl)-2,2-butane, 1,3-bis[2-(4-cyanato phenyl)propyl]benzene, bis(4-cyanatophenyl)ether, 4,4′-dicyanatodiphenyl, bis(4-cyanato-3,5-dimethylphenyl)methane, tris(4-cyanatophenyl)ethane, cyanated novolak, 1,3-bis[4-cyanatophenyl-1-(1-methylethylidene)]benzene, cyanated phenoldicyclopentadiene adduct, and the like. Polycyanate ester monomers utilized in accordance with the present invention may be readily prepared by reacting appropriate dihydric or polyhydric phenols with a cyanogen halide in the presence of an acid acceptor.

Monomers that can optionally be combined with polycyanate ester monomer(s) in accordance with the present invention are selected from those monomers which undergo addition polymerization. Such monomers include vinyl ethers, divinyl ethers, diallyl ethers, dimethacrylates, dipropargyl ethers, mixed propargyl allyl ethers, monomaleimides, bismaleimides, and the like. Examples of such monomers include cyclohexanedimethanol monovinyl ether, trisallylcyanurate, 1,1-bis(4-allyloxyphenyl)ethane, 1,1-bis(4-propargyloxyphenyl)ethane, 1,1-bis(4-allyloxyphenyl-4′-propargyloxyphenyl)ethane, 3-(2,2-dimethyltrimethylene acetal)-1-maleimidobenzene, 2,2,4-trimethylhexamethylene-1,6-bismaleimide, 2,2-bis[4-(4-maleimidophenoxy)phenyl]propane, and the like.

Additional cyanate esters contemplated for use in the practice of the present invention are well known in the art. See, for example, U.S. Pat. No. 5,718,941, the entire contents of which are hereby incorporated by reference herein.

Examples of cyanate esters that can be used herein include those commercially available under the trade name Primaset™, which include Primaset™ BA-3000/S, Primaset™ DT-7000, Primaset™ LECY, Primaset™ PT-15, Primaset™ PT-30/S, Primaset™ PT 60/S, Primaset™ PTC-2500, and the like.

When present, oxetanes (i.e., 1,3-propylene oxides) are heterocyclic organic compounds with the molecular formula C₃H₆O, having a four-membered ring with three carbon atoms and one oxygen atom. The term oxetane also refers generally to any organic compound containing an oxetane ring. See, for example, Burkhard et al., in Angew. Chem. Int. Ed. 2010, 49, 9052-9067, the entire contents of which are hereby incorporated by reference herein.

Examples of oxetanes that can be included in the inventive compositions are those commercially available from Toagosei Co. Ltd. including OXT-221, OXT-212, OXT-101, OXT-121, and the like.

When present, polyesters contemplated for use in the practice of the present invention refer to condensation polymers formed by the reaction of polyols (also known as polyhydric alcohols), with saturated or unsaturated dibasic acids. Typical polyols used are glycols such as ethylene glycol; acids commonly used are phthalic acid and maleic acid. Water, a by-product of esterification reactions, is continuously removed, driving the reaction to completion. The use of unsaturated polyesters and additives such as styrene lowers the viscosity of the resin. The initially liquid resin is converted to a solid by cross-linking chains. This is done by creating free radicals at unsaturated bonds, which propagate to other unsaturated bonds in adjacent molecules in a chain reaction, linking the adjacent chains in the process. Also, double bonds present in unsaturated polyesters can crosslink with bismaleimides are elevated temperature by way of the ene reaction.

When present, polyurethanes contemplated for use in the practice of the present invention refer to polymers composed of a chain of organic units joined by carbamate (urethane) links. Polyurethane polymers are formed by reacting an isocyanate with a polyol. Both the isocyanates and polyols used to make polyurethanes contain on average two or more functional groups per molecule.

When present, polyimides contemplated for use in the practice of the present invention refer to polymers composed of a chain of organic units joined by imide linkages (i.e., —C(O)—N(R)—C(O)—). Polyimide polymers can be formed by a variety of reactions, i.e., by reacting a dianhydride and a diamine, by the reaction between a dianhydride and a diisocyanate, and the like.

When present, melamines contemplated for use in the practice of the present invention refer to hard, thermosetting plastic materials made from melamine (i.e., 1,3,5-triazine-2,4,6-triamine) and formaldehyde by polymerization. In its butylated form, it can be dissolved in n-butanol and/or xylene. It can be used to cross-link with other resins such as alkyd, epoxy, acrylic, and polyester resins.

When present, urea-formaldehydes contemplated for use in the practice of the present invention refers to a non-transparent thermosetting resin or plastic made from urea and formaldehyde heated in the presence of a mild base such as ammonia or pyridine.

When present, phenol-formaldehydes contemplated for use in the practice of the present invention refer to synthetic polymers obtained by the reaction of phenol or substituted phenol with formaldehyde.

Particulate fillers contemplated for optional use in the practice of the present invention include silica, calcium silicate, aluminum hydroxide, magnesium hydroxide, calcium carbonate, magnesium carbonate, aluminum oxide (Al₂O₃), zinc oxide (ZnO), magnesium oxide (MgO), aluminum nitride (AlN), boron nitride (BN), carbon nanotubes, diamond, clay, aluminosilicate, and the like, as well as mixtures of any two or more thereof. In some embodiments, the particulate filler is silica.

Typically, fillers optionally employed in invention formulations have a particle size in the range of about 0.005 μm (i.e., 5 nm) up to about 20 μm. In certain embodiments, filler employed herein has a particle size in the range of about 0.1 μm up to about 5 μm.

Compositions according to the present invention optionally comprise in the range of about 30-75 wt % of the particulate filler. In some embodiments, compositions according to the present invention comprise in the range of about 40-60 wt % of the particulate filler.

In some embodiments of the present invention, formulations employed in the invention methods include one or more photoinitiator. When present, photoiniator is present in the range of about 0.1 up to 10 wt %.

Exemplary photoinitiators contemplated for use herein include acetophenone-based, thioxanthone-based, benzoin-based, peroxide-based and phosphine oxide-based photoinitiators. Specific examples include diethoxyacetophenone; 4-phenoxydichloroacetophenone, benzoin, benzoin ethyl ether, benzoin isopropyl ether, benzyl dimethyl ketal, benzophenone, 4-phenyl benzophenone, acrylated benzophenone, thioxanthone, 2-ethylanthraquinone, triphosphine oxide (TPO), triphenyl phosphine oxide (TPPO), mono acylphosphine oxide (MAPO), bis acylphosphine oxide (BAPO), and the like. The Irgacur and Darocur lines of photoinitiators sold by BASF are examples of useful photoinitiators.

Invention compositions may optionally further comprise in the range of about 0.2-2 wt % of a free-radical polymerization initiator. In certain embodiments, invention compositions may further comprise in the range of about 0.2-1 wt % of a free radical polymerization initiator.

Exemplary free radical initiators include peroxy esters, peroxy carbonates, hydroperoxides, alkylperoxides, arylperoxides, azo compounds, and the like.

Invention compositions optionally further comprise one or more flow additives, adhesion promoters, rheology modifiers, toughening agents, fluxing agents, film flexibilizers, an epoxy-curing catalyst (e.g., imidazole), a curing agent (e.g., a radical initiator such as dicumyl peroxide), radical polymerization regulator (e.g., 8-hydroxy quinoline), and/or radical stabilizer, as well as mixtures of any two or more thereof.

As used herein, the term “flow additives” refers to compounds which modify the viscosity of the formulation to which they are introduced. Exemplary compounds which impart such properties include silicone polymers, ethyl acrylate/2-ethylhexyl acrylate copolymers, alkylol ammonium salts of phosphoric acid esters of ketoxime, and the like, as well as combinations of any two or more thereof.

As used herein, the term “adhesion promoters” refers to compounds which enhance the adhesive properties of the formulation to which they are introduced.

As used herein, the term “adhesion depromoters” refers to compounds which reduce the adhesive properties of the formulation to which they are introduced.

As used herein, the term “rheology modifiers” refers to additives which modify one or more physical properties of the formulation to which they are introduced.

As used herein, the term “toughening agents” refers to additives which enhance the impact resistance of the formulation to which they are introduced.

As used herein, the term “radical stabilizers” refers to compounds such as hydroquinones, benzoquinones, hindered phenols, hindered amines (e.g., thiocarbonylthio-based compounds), benzotriazole-based ultraviolet absorbers, triazine-based ultraviolet absorbers, benzophenone-based ultraviolet absorbers, benzoate-based ultraviolet absorbers, hindered amine-based ultraviolet absorbers, nitroxide radical-based compounds, and the like, as well as combinations of any two or more thereof.

When present, invention compositions comprise in the range of about 0.1-1 wt % of the radical stabilizer. In some embodiments, invention compositions comprise in the range of about 0.1-0.6 wt % of the radical stabilizer.

Invention compositions may also optionally contain one or more non-reactive diluents. When non-reactive diluent is present, invention compositions comprise in the range of about 10-50 wt % thereof, relative to the total composition. In certain embodiments, invention compositions comprise in the range of about 20-40 wt % non-reactive diluent.

Exemplary non-reactive diluents contemplated for use herein, when present, include aromatic hydrocarbons (e.g., benzene, toluene, xylene, and the like), saturated hydrocarbons (e.g., hexane, cyclohexane, heptane, tetradecane), chlorinated hydrocarbons (e.g., methylene chloride, chloroform, carbon tetrachloride, dichloroethane, trichloroethylene, and the like), ethers (e.g., diethyl ether, tetrahydrofuran, dioxane, glycol ethers, monoalkyl or dialkyl ethers of ethylene glycol, and the like), polyols (e.g., polyethylene glycol, propylene glycol, polypropylene glycol, and the like), esters (e.g., ethyl acetate, butyl acetate, methoxy propyl acetate, and the like); dibasic esters, alpha-terpineol, beta-terpineol, kerosene, dibutylphthalate, butyl carbitol, butyl carbitol acetate, carbitol acetate, ethyl carbitol acetate, hexylene glycol, high boiling alcohols and esters thereof, glycol ethers, ketones (e.g., acetone, methyl ethyl ketone, and the like), amides (e.g., dimethylformamide, dimethylacetamide, and the like), heteroaromatic compounds (e.g., N-methylpyrrolidone, and the like), and the like, as well as mixtures of any two or more thereof.

Hydroxy-containing diluents contemplated for use herein include water and hydroxy-containing compounds having a C₁ up to about a C₁₀ backbone. Exemplary hydroxy-containing diluents include water, methanol, ethanol, propanol, ethylene glycol, propylene glycol, glycerol, terpineol, and the like, as well as mixtures of any two or more thereof.

The amount of hydroxy-containing diluent contemplated for use in accordance with the present invention can vary widely, typically falling in the range of about 5 up to about 80 weight percent of the composition. In certain embodiments, the amount of hydroxy-containing diluent falls in the range of about 10 up to 60 weight percent of the total composition. In some embodiments, the amount of hydroxy-containing diluent falls in the range of about 20 up to about 50 weight percent of the total composition.

In certain embodiments, invention compositions typically comprise:
at least 60 wt % of a maleimide having the structure:

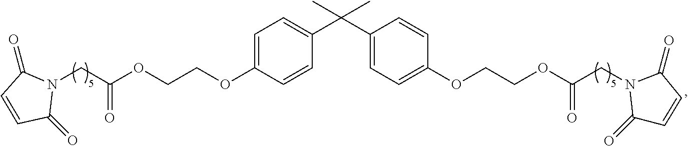

at least 30 wt % of tricyclodecane acrylate, and
at least 1.5 wt % of the photoinitiator.

In certain embodiments, invention compositions typically comprise:
at least 60 wt % of a maleimide having the structure:

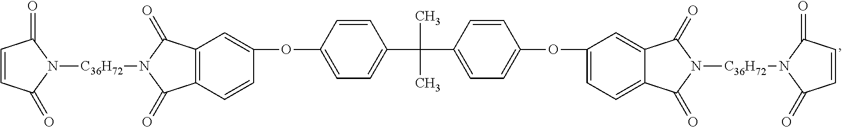

at least 30 wt % of tricyclodecane acrylate, and
at least 1.5 wt % of the photoinitiator.

In some embodiments, invention compositions may further comprise one or more of:
at least 1 wt % of a fluxing agent;
at least 0.1 wt % of an adhesion promoter; and/or
at least 4 wt % of a toughening agent.

In some embodiments, invention compositions may further comprise one or more of:
up to about 10 wt % of a fluxing agent,
up to about 2 wt % of an adhesion promoter; and/or
up to about 16 wt % of a toughening agent.

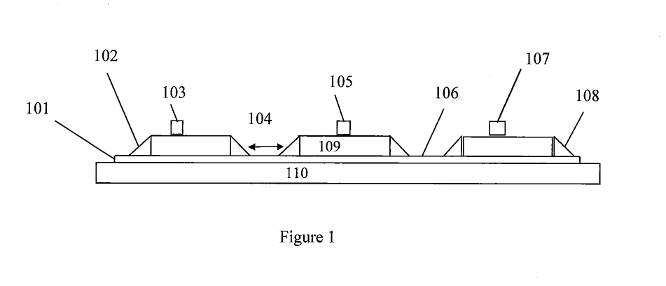

In accordance with another embodiment of the present invention, there are provided debondable assemblies comprising a substrate and a carrier reversibly bonded by the methods described herein (see, for example, FIG. 1).

In accordance with yet another embodiment of the present invention, there are provided methods for debonding a substrate and a carrier, the methods comprising:
allowing an adhered assembly comprising a substrate and a carrier bound by an aliquot of a debondable adhesive composition to cool to a temperature below about 50° C.,
separating the substrate and the carrier; and thereafter
removing any residual adhesive composition from the debonded substrate and/or carrier,
   where the debondable adhesive composition comprises:
one or more BMI, nadimide or itaconimide oligomer(s);
in the range of about 10 up to 90 wt % of at least one ethylenically unsaturated co-monomer;
optionally a reactive organic diluent, which, when present, is present in the range of about 1 up to 50 wt %;
optionally a non-reactive organic diluent, which, when present, is present in the range of about 5 up to 40 wt %; and
optionally a photoinitiator;
   where the composition is further characterized by one or more of the following:
the composition is stable to a temperature of at least 200° C.,
the composition is chemically resistant to acids, bases and solvents,
the composition undergoes low level of shrinkage upon curing thereof,
the composition has high adhesion to suitable substrates, especially at elevated temperatures,
the composition is heat and/or light curable, and
the composition is debondable at or about room temperature.

In accordance with yet another embodiment of the present invention, there are provided methods to reinforce a fragile carrier for the fabrication thereof, the methods comprising:
forming an assembly by bringing a substrate and a carrier in direct contact with one another, separated only by a neat aliquot of debondable adhesive composition, a suspension of debondable adhesive in a diluent therefor, or the debondable adhesive is applied to a support therefor); and thereafter
curing the resulting assembly under conditions suitable to promote adhesion therebetween,
   where the debondable adhesive composition comprises:
one or more BMI, nadimide or itaconimide oligomer(s);
in the range of about 10 up to 90 wt % of at least one ethylenically unsaturated co-monomer;
optionally a reactive organic diluent, which, when present, is present in the range of about 1 up to 50 wt %;
optionally a non-reactive organic diluent, which, when present, is present in the range of about 5 up to 40 wt %; and
optionally a photoinitiator;
   where the composition is further characterized by one or more of the following:
the composition is stable to a temperature of at least 200° C.,
the composition is chemically resistant to acids, bases and solvents,
the composition undergoes low level of shrinkage upon curing thereof,
the composition has high adhesion to suitable substrates, especially at elevated temperatures,
the composition is heat and/or light curable, and
the composition is debondable at or about room temperature.

Fragile carriers contemplated for use herein include glass, ceramic, stainless steel, silicon wafers, polyimide films, polyester films, and the like.

Fragile carriers contemplated for use herein typically have a thickness in the range of about 0.6 up to 1.3 mm.

As readily recognized by those of skill in the art, carriers employed herein may optionally be chemically and/or physically pre-treated to improve the adhesion thereto.

Suitable substrates contemplated for use herein include polyethylene terephthalates, polymethyl methacrylates, polyethylenes, polypropylenes, polycarbonates, epoxy resins, polyimides, polyamides, polyesters, glass, Si die with silicon nitride passivation, Si die with polyimide passivation, BT substrates, bare Si, SR4 substrates, SR5 substrates, and the like.

In accordance with yet another embodiment of the present invention, there are provided debondable adhesive compositions comprising:
one or more BMI, nadimide or itaconimide oligomer(s);
in the range of about 10 up to 90 wt % of at least one ethylenically unsaturated co-monomer;
optionally a reactive organic diluent, which, when present, is present in the range of about 1 up to 50 wt %;
optionally a non-reactive organic diluent, which, when present, is present in the range of about 5 up to 40 wt %; and
optionally a photoinitiator;
   where the composition is further characterized by one or more of the following:
the composition is stable to a temperature of at least 200° C.,
the composition is chemically resistant to acids, bases and solvents,
the composition undergoes low level of shrinkage upon curing thereof,
the composition has high adhesion to suitable substrates, especially at elevated temperatures,
the composition is heat and/or light curable, and
the composition is debondable at or about room temperature.

Various aspects of the present invention are illustrated by the following non-limiting examples. The examples are for illustrative purposes and are not a limitation on any practice of the present invention. It will be understood that variations and modifications can be made without departing from the spirit and scope of the invention. One of ordinary skill in the art readily knows how to synthesize or commercially obtain the reagents and components described herein.

### EXAMPLES

### Example 1

### General Procedure for Synthesis of Bismaleimides

A 1 L 3 necked flask equipped with a condenser and magnetic stir bar was charged with 4,4′-isopropylidenebis(2-phenoxyethanol) (73.6 g, 232 mmoles), 6-maleimidocaproic acid (103.2 g, 488 mmol), methyl hydroquinone (400 mg) in toluene (500 mL). PTSA (2.2 g, 11 mmol) was added and the resulting mixture refluxed with azeotropic collection of water. After about 8 h when the water collection stopped, the reaction was stopped. After cooling to room temperature, 400 mL of ethyl acetate was added and the organic layer was filtered off, washed twice with aqueous NaHCO₃ solution and twice with water. After drying over anhydrous Na₂SO₄, the mixture was filtered. 300 ppm of methylhydroquinone was added and the solvent evaporated to give corresponding bismaleimide (135 g, 76%):

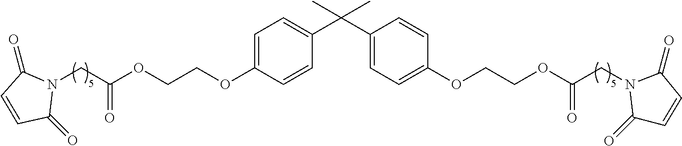

Other bismaleimides were made similarly starting from appropriate starting materials.

### Example 2

Two preferred properties for debondable adhesives according to the present invention are that they are stable and maintain their integrity at temperatures at 300° C. and above, to as high as 440° C., and that they easily and cleanly debond at ambient temperature. In the following examples, visual evidence of fine line cracking at high temperature indicates instability, and evidence of peel strength higher than 5N/25 mm indicates that the adhesive can not be cleanly removed.

The test vehicle was an assembly of two glass slides 5 cm×7.5 cm, from VWR International with the adhesive composition deposed between the two slides. The bondline thickness for all samples, unless otherwise stated, was 0.125 mm. The assemblies were placed on a 150° C. Cole Parmer Digital hotplate for 30 minutes in air to harden the adhesive.

To test high temperature stability, a Thermo Scientific BF5800 Furnace was used to heat the assemblies to determined temperatures. When visual inspection of the adhesive after heating revealed fine lines or cracks, the adhesive was determined to be unstable.

Weight loss of the adhesive in test vehicles was used as another measure of stability. The lower the weight loss, the more stable the adhesive. Samples were weighed before and after heating for one hour at 400° C. using a Thermogravimetric Analyzer (TGA), Pyris 1 from Perkin Elmer and the weight loss calculated. A weight loss of less than 9.6% is deemed acceptable and the adhesive deemed stable. In one embodiment, a preferred weight loss is 7.3% or less.

In examples where UV was used as the curing method, a Dymax EC series 450W UV lamp was used to irradiate the test vehicles for a specific time.

Debonding tests were performed using a Shimpo FGV-20XY digital force gauge: the top glass slide of the test vehicle was peeled off the stabilized bottom glass slide and the peel force (deemed the debonding force) calculated and normalized to N/25 mm.

The materials used in the examples are presented in Table 1.

TABLE 1

| Raw Material | 392473B | 398709A | 398715A |
|---|---|---|---|
| BMI-6 | | 81.10 | 65.48 |
| BMI-24-405A | | 15.01 | 30.48 |
| BMI-1500 | 63.49 | | |
| Tricyclodecane Acrylate | 32.48 | | |
| Diphenyl (2,4,6-trimethylbenzoyl) | 2.02 | 2.07 | 2.01 |
| Phosphine Oxide | | | |
| Maleimidocaproic Acid (MCA) | 2.01 | 1.82 | 2.03 |
| | 100.00 | 100.00 | 100.00 |

Each of the formulations described above were subjected to performance tests (for which the results are set forth in the following Table 2).

TABLE 2

| No. | Material Screening Test List | | Requirement | 392473B | 398709A | 398715A |
|---|---|---|---|---|---|---|
| 1 | Viscosity (mPas) | 25° C. (measured) | 9,000-13,000 | 10,830 | 33,620 | 19,100 |
| | | 25° C. (reported) | for slit | | | |
| | | 60° C. (reported) | coating (App | | | |
| | | | 1) | | | |
| | | | 4,000-6,000 | | | |
| | | | for | | | |
| | | | dispensing | | | |
| | | | (App 2&3) | | | |
| 2 | Photorheometry | Crossover Time | | 18.2 | 8.5 | 7.4 |
| | | (sec.) | | | | |
| | | Complex | | 4.24E+06 | 5.17E+05 | 1.04E+06 |
| | | Modulus, G* @ | | | | |
| | | 30 min. (Pa) | | | | |
| | | Shrinkage @ 30 min. | <3% | 2.25 | 0.84 | 1.29 |
| | | (%) | | | | |
| 3 | TGA - Weight Loss | 10° C./min. to | <3% | 5.21 | 2.667 | 2.215 |
| | in N2 (%) | 300° C., | | | | |
| | | isothermal @ | | | | |
| | | 300° C. for 30 min. | | | | |
| | TGA - Weight Loss | 10° C./min. to | | | | |
| | in Air (%) | 300° C., | <3% | | 7.920 | 6.548 |
| | | isothermal @ | | | | |
| | | 300° C. for 30 min. | | | | |
| 4 | Cross Bond Strength | Initial (24 hrs) | 0.3 to 0.6 | >0.73 | 0.31 | |
| | (MPa) | After 300° C., 20 mins | | | | |
| | | After 240° C., | | 0.21 | 0.56 | |
| | | 5 hrs, then 300° C., | | | | |
| | | 20 mins | | | | |
| 5 | Application #1 | After 240° C., 1 hr, | No crack, no | pass | pass | |
| | Simulation | 5 cycles then | delamination | | | |
| | Application #2 | 300° C., 10 mins | | pass | pass | |
| | Simulation | on Glass | | | | |
| | Application #3 | | | pass | pass | |
| | Simulation | | | | | |
| | Reworkability (1 = | | | pass-2 | pass-2 | |
| | brittle, 2 = easy | | | | | |
| | debond, 3 = | | | | | |
| | average debond, 4 = | | | | | |
| | difficult debond, 5 = | | | | | |
| | non-debondable) | | | | | |
| 6 | Application #1 | RT-240° C., 1 hr- | No crack, no | fail | pass | pass |
| | Simulation | RT-240° C., 1 hr- | delamination | | | |
| | Application #2 | 300° C., 5 min-RT- | | fail | pass | pass |
| | Simulation | 240° C., 1 hr-RT- | | | | |
| | Application #3 | 240° C., I hr-RT- | | pass | pass | pass |
| | Simulation | 240° C., 1 hr on | | | | |
| | Reworkability (1 = | Glass | | fail | fail-4 | fail-4 |
| | brittle, 2 = easy | | | | | |
| | debond, 3 = | | | | | |
| | average debond, 4 = | | | | | |
| | difficult debond, 5 = | | | | | |
| | non-debondable) | | | | | |

Various modifications of the present invention, in addition to those shown and described herein, will be apparent to those skilled in the art of the above description. Such modifications are also intended to fall within the scope of the appended claims.

Patents and publications mentioned in the specification are indicative of the levels of those skilled in the art to which the invention pertains. These patents and publications are incorporated herein by reference to the same extent as if each individual application or publication was specifically and individually incorporated herein by reference.

The foregoing description is illustrative of particular embodiments of the invention, but is not meant to be a limitation upon the practice thereof. The following claims, including all equivalents thereof, are intended to define the scope of the invention.

That which is claimed is:

1. A method of making a debondable assembly, said method comprising:
forming an assembly by bringing a substrate and a carrier in contact with one another, separated only by an aliquot of a debondable adhesive composition; and thereafter
curing the resulting assembly under conditions suitable to promote adhesion therebetween,
wherein said substrate is a fragile material;
wherein said carrier imparts structural integrity to said substrate upon bonding thereto;
wherein said debondable adhesive composition comprises:
in the range of about 10 up to 95 wt % of one or more bis-maleimide, nadimide or itaconimide oligomer(s);
in the range of about 5 up to 90 wt % of at least one ethylenically unsaturated co-monomer;
optionally a reactive organic diluent, which, when present, is present in the range of about 1 up to 50 wt %;
optionally a non-reactive organic diluent, which, when present, is present in the range of about 5 up to 40 wt %; and
optionally a photoinitiator;
wherein said composition is further characterized by one or more of the following:
said composition is stable to a temperature of at least 200° C.,
said composition is chemically resistant to acids, bases and solvents,
said composition undergoes low level of shrinkage upon curing thereof,
said composition has high adhesion to suitable substrates, especially at elevated temperatures,
said composition is heat and/or light curable, and
said composition is debondable at or about room temperature.

2. The method of claim 1 wherein said maleimide, nadimide or itaconimide, has the structure: 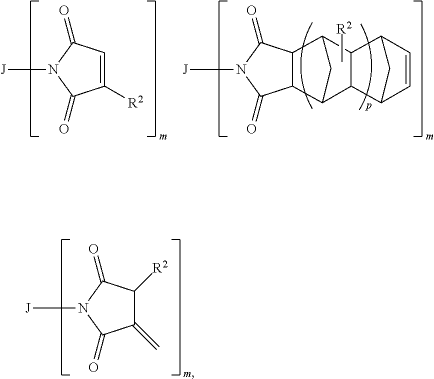
respectively, wherein:
m is 1-15,
p is 0-15,
each R² is independently selected from hydrogen or lower alkyl (such as C₁₋₅), and
J is a monovalent or a polyvalent radical comprising organic or organosiloxane radicals, and
combinations of two or more thereof.

3. The method of claim 2 wherein J is a monovalent or polyvalent radical selected from:
hydrocarbyl or substituted hydrocarbyl species typically having in the range of about 6 up to about 500 carbon atoms, where the hydrocarbyl species is selected from alkyl, alkenyl, alkynyl, cycloalkyl, cycloalkenyl, aryl, alkylaryl, arylalkyl, aryalkenyl, alkenylaryl, arylalkynyl or alkynylaryl, provided, however, that X can be aryl only when X comprises a combination of two or more different species;
hydrocarbylene or substituted hydrocarbylene species typically having in the range of about 6 up to about 500 carbon atoms, where the hydrocarbylene species are selected from alkylene, alkenylene, alkynylene, cycloalkylene, cycloalkenylene, arylene, alkylarylene, arylalkylene, arylalkenylene, alkenylarylene, arylalkynylene or alkynylarylene,
heterocyclic or substituted heterocyclic species typically having in the range of about 6 up to about 500 carbon atoms,
polysiloxane, or
polysiloxane-polyurethane block copolymers, as well as
combinations of one or more of the above with a linker selected from covalent bond, —O—, —S—, —NR—, —NR—C(O)—, —NR—C(O)—O—, —NR—C(O)—NR—, —S—C(O)—, —S—C(O)—O—, —S—C(O)—NR—, —O—S(O)₂—, —O—S(O)₂—O—, —O—S(O)₂—NR—, —O—S(O)—, —O—S(O)—O—, —O—S(O)—NR—, —O—NR—C(O)—, —O—NR—C(O)—O—, —O—NR—C(O)—NR—, —NR—O—C(O)—, —NR—O—C(O)—O—, —NR—O—C(O)—NR—, —O—NR—C(S)—, —O—NR—C(S)—O—, —O—NR—C(S)—NR—, —NR—O—C(S)—, —NR—O—C(S)—O—, —NR—O—C(S)—NR—, —O—C(S)—, —O—C(S)—O—, —O—C(S)—NR—, —NR—C(S)—, —NR—C(S)—O—, —NR—C(S)—NR—, —S—S(O)₂—, —S—S(O)₂—O—, —S—S(O)₂—NR—, —NR—O—S(O)—, —NR—O—S(O)—O—, —NR—O—S(O)—NR—, —NR—O—S(O)₂—, —NR—O—S(O)₂—O—, —NR—O—S(O)₂—NR—, —O—NR—S(O)—, —O—NR—S(O)—O—, —O—NR—S(O)—NR—, —O—NR—S(O)₂—O—, —O—NR—S(O)₂—NR—, —O—NR—S(O)₂—, —O—P(O)R₂—, —S—P(O)R₂—, or —NR—P(O)R₂—; where each R is independently hydrogen, alkyl or substituted alkyl.

4. The method of claim 2 wherein J is oxyalkyl, thioalkyl, aminoalkyl, carboxylalkyl, oxyalkenyl, thioalkenyl, aminoalkenyl, carboxyalkenyl, oxyalkynyl, thioalkynyl, aminoalkynyl, carboxyalkynyl, oxycycloalkyl, thiocycloalkyl, aminocycloalkyl, carboxycycloalkyl, oxycloalkenyl, thiocycloalkenyl, aminocycloalkenyl, carboxycycloalkenyl, heterocyclic, oxyheterocyclic, thioheterocyclic, aminoheterocyclic, carboxyheterocyclic, oxyaryl, thioaryl, aminoaryl, carboxyaryl, heteroaryl, oxyheteroaryl, thioheteroaryl, aminoheteroaryl, carboxyheteroaryl, oxyalkylaryl, thioalkylaryl, aminoalkylaryl, carboxyalkylaryl, oxyarylalkyl, thioarylalkyl, aminoarylalkyl, carboxyarylalkyl, oxyarylalkenyl, thioarylalkenyl, aminoarylalkenyl, carboxyarylalkenyl, oxyalkenylaryl, thioalkenylaryl, aminoalkenylaryl, carboxyalkenylaryl, oxyarylalkynyl, thioarylalkynyl, aminoarylalkynyl, carboxyarylalkynyl, oxyalkynylaryl, thioalkynylaryl, aminoalkynylaryl or carboxyalkynylaryl, oxyalkylene, thioalkylene, aminoalkylene, carboxyalkylene, oxyalkenylene, thioalkenylene, aminoalkenylene, carboxyalkenylene, oxyalkynylene, thioalkynylene, aminoalkynylene, carboxyalkynylene, oxycycloalkylene, thiocycloalkylene, aminocycloalkylene, carboxycycloalkylene, oxycycloalkenylene, thiocycloalkenylene, aminocycloalkenylene, carboxycycloalkenylene, oxyarylene, thioarylene, aminoarylene, carboxyarylene, oxyalkylarylene, thioalkylarylene, aminoalkylarylene, carboxyalkylarylene, oxyarylalkylene, thioarylalkylene, aminoarylalkylene, carboxyarylalkylene, oxyarylalkenylene, thioarylalkenylene, aminoarylalkenylene, carboxyarylalkenylene, oxyalkenylarylene, thioalkenylarylene, amino alkenylarylene, carboxyalkenylarylene, oxyarylalkynylene, thioarylalkynylene, amino arylalkynylene, carboxy arylalkynylene, oxyalkynylarylene, thioalkynylarylene, aminoalkynylarylene, carboxyalkynylarylene, heteroarylene, oxyheteroarylene, thioheteroarylene, aminoheteroarylene, carboxyheteroarylene, heteroatom-containing di- or polyvalent cyclic moiety, oxyheteroatom-containing di- or polyvalent cyclic moiety, thioheteroatom-containing di- or polyvalent cyclic moiety, aminoheteroatom-containing di- or polyvalent cyclic moiety, or a carboxyheteroatom-containing di- or polyvalent cyclic moiety.

5. The method of claim 1 wherein said maleimide, nadimide or itaconimide is selected from the group consisting of: 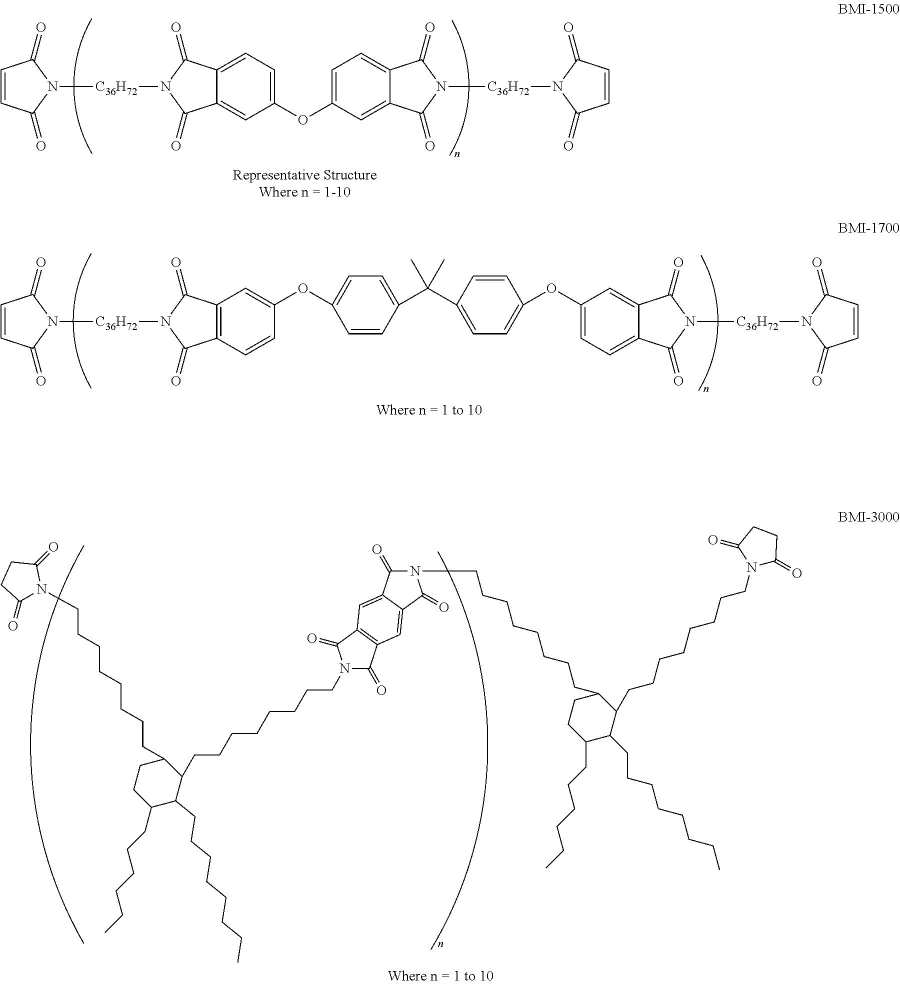 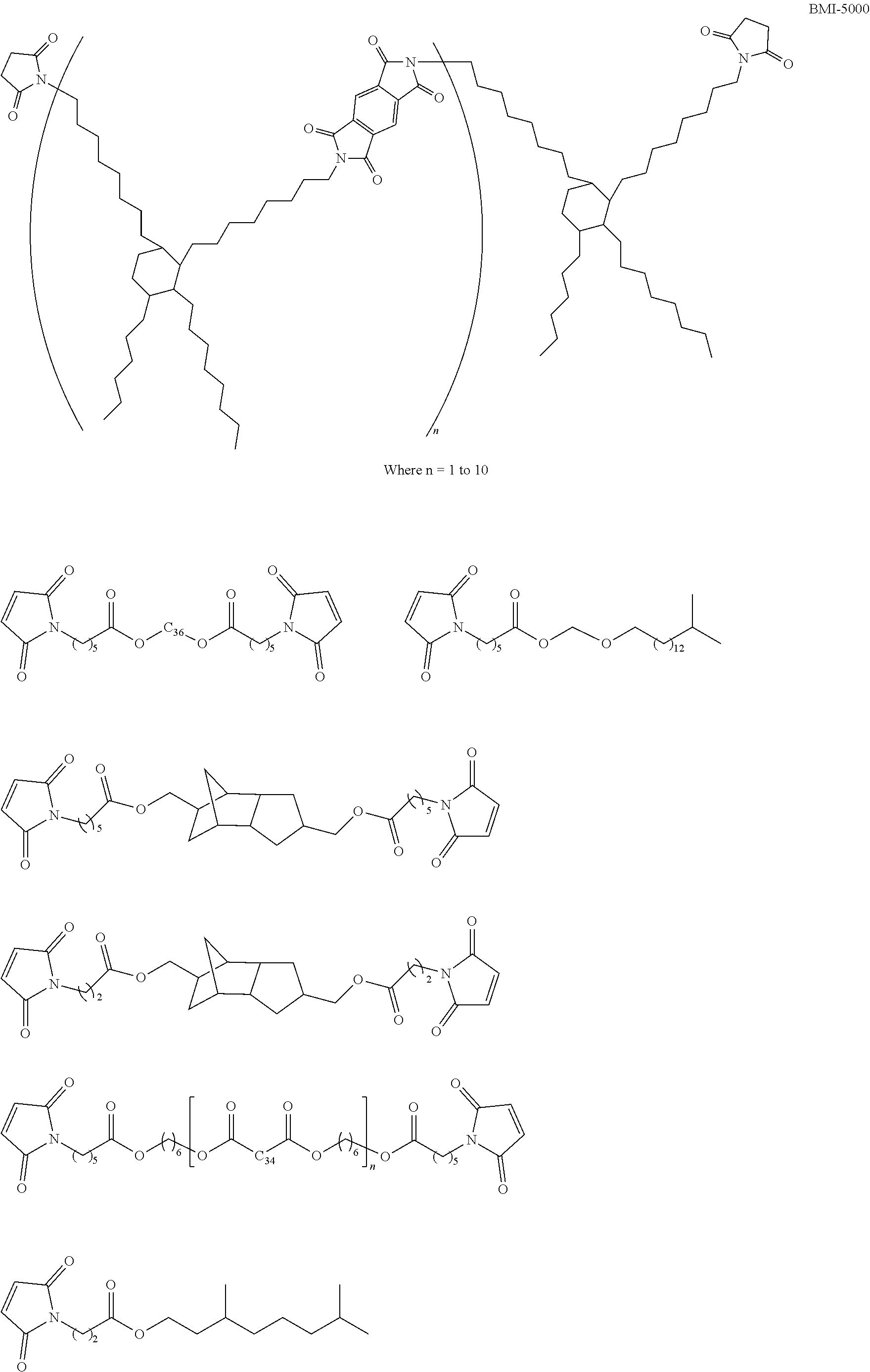 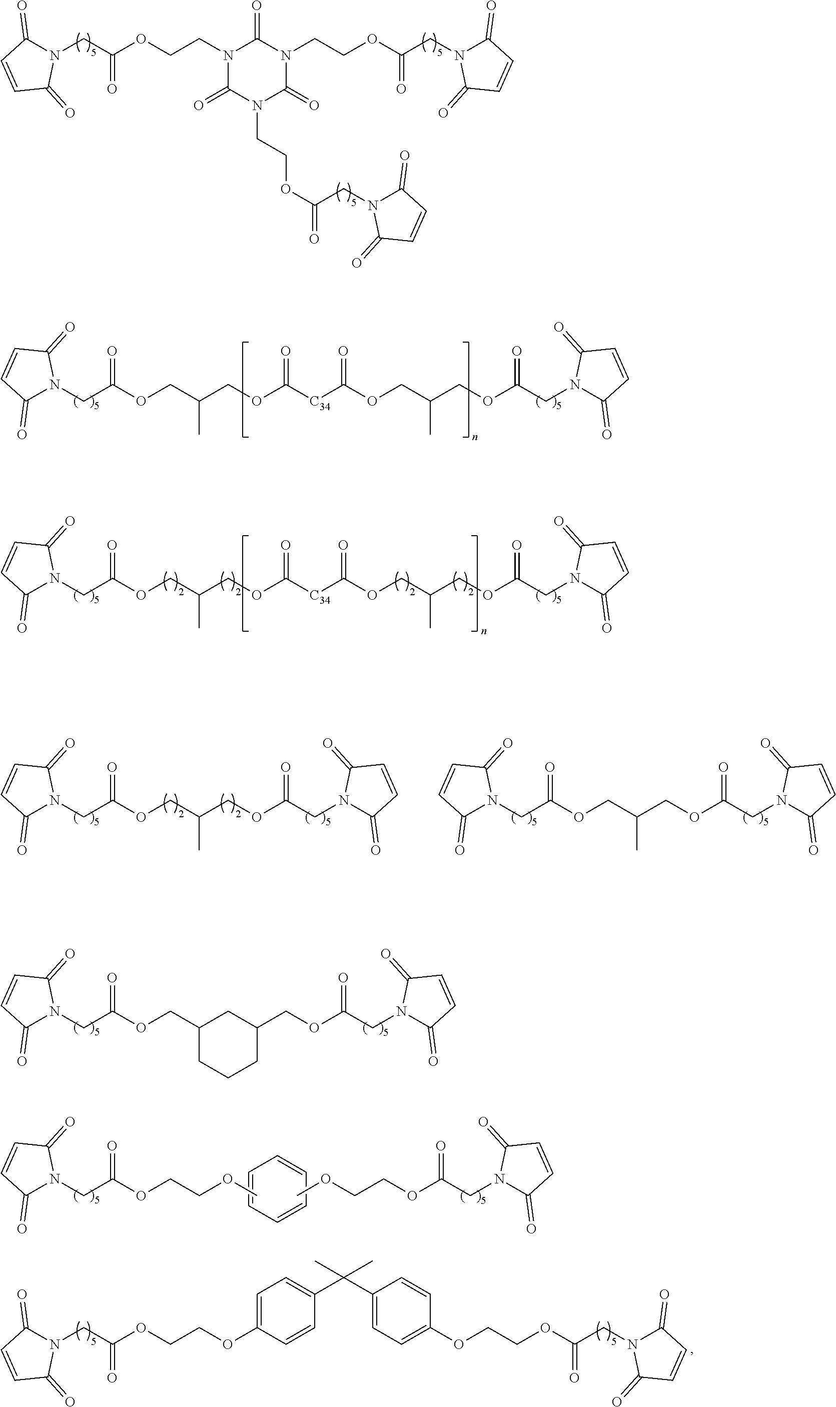
as well as mixtures of any two or more thereof.

6. The method of claim 1 wherein said maleimide, nadimide or itaconimide is an imide-extended, low molecular weight bis-maleimide oligomer having the structure:

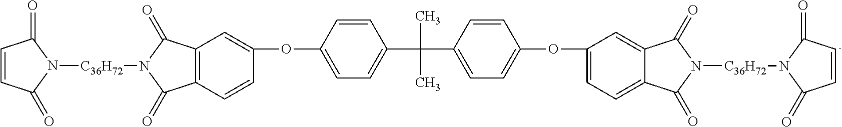

7. The method of claim 1 wherein said ethylenically unsaturated co-monomer is selected from the group consisting of (meth)acrylates, vinyl ethers, vinyl esters, styrenic compounds, allyl compounds, polybutadienes, cinnamates, crotonates, and mixtures of any two or more thereof.

8. The method of claim 7 wherein said (meth)acrylate is a monofunctional (meth)acrylate, a difunctional (meth)acrylate, a trifunctional (meth)acrylate, or a polyfunctional (meth)acrylate, as well as mixtures of any two or more thereof.

9. The method of claim 7 wherein said vinyl ether has the structure:
CH₂═CH—OR
wherein R is alkyl, substituted alkyl, alkenyl, substituted alkenyl, aryl, or substituted aryl.

10. The method of claim 7 wherein said vinyl ester has the structure:
CH₂═CH—O—C(O)—R′
or
CH₂═CH—C(O)—O—R′
wherein R′ is alkyl or substituted alkyl.

11. The method of claim 7 wherein said styrenic compound has the structure:
Ph-CH═CH₂
wherein Ph is phenyl or substituted phenyl.

12. The method of claim 7 wherein said allyl compound has the structure:
CH₂═CH—CH₂—X
wherein X is alkyl, substituted alkyl, aryl, or substituted aryl.

13. The method of claim 1 wherein said one or more reactive organic diluent is present, and is selected from the group consisting of thiols, cyanate esters, and mixtures of any two or more thereof.

14. The method of claim 1 wherein said photoinitiator is present.

15. The method of claim 14 wherein said photoiniator is present in the range of about 0.1 up to 10 wt %.

16. The method of claim 15 wherein said photoinitiator is selected from the group consisting of acetophenone-based, thioxanthone-based, benzoin-based, peroxide-based and phosphine oxide-based photoinitiators.

17. The method of claim 1 wherein said composition further comprises one or more flow additives, adhesion promoters, rheology modifiers, toughening agents, fluxing agents, film flexibilizers, a curing agent, as well as mixtures of any two or more thereof.

18. The method of claim 1 wherein said non-reactive organic diluent is present, and is selected from the group consisting of aromatic hydrocarbons, saturated hydrocarbons, chlorinated hydrocarbons, ethers, polyols, esters; dibasic esters, alpha-terpineol, beta-terpineol, kerosene, dibutylphthalate, butyl carbitol, butyl carbitol acetate, carbitol acetate, ethyl carbitol acetate, hexylene glycol, high boiling alcohols and esters thereof, glycol ethers, ketones, amides, heteroaromatic compounds, and mixtures of any two or more thereof.

19. The method of claim 1 wherein said composition comprises:
at least 20 wt % of said bis-maleimide, nadimide or itaconimide oligomer,
no greater than 80 wt % of said at least one ethylenically unsaturated co-monomer, and
at least 1 wt % of said photoinitiator.

20. A debondable assembly comprising a substrate and a carrier reversibly bonded by the method of claim 1.

21. A method for debonding a substrate and a carrier, said method comprising:
allowing an adhered assembly comprising a substrate and a carrier bound by an aliquot of a debondable adhesive composition to cool to a temperature below about 50° C.,
separating said substrate and said carrier; and thereafter
removing any residual adhesive composition from the debonded substrate and/or carrier,
wherein said debondable adhesive composition comprises:
one or more bis-maleimide, nadimide or itaconimide oligomer(s);
in the range of about 10 up to 90 wt % of at least one ethylenically unsaturated co-monomer;
optionally a reactive organic diluent, which, when present, is present in the range of about 1 up to 50 wt %;
optionally a non-reactive organic diluent, which, when present, is present in the range of about 5 up to 40 wt %; and
optionally a photoinitiator;
wherein said composition is further characterized by one or more of the following:
said composition is stable to a temperature of at least 200° C.,
said composition is chemically resistant to acids, bases and solvents,
said composition undergoes low level of shrinkage upon curing thereof,
said composition has high adhesion to suitable substrates, especially at elevated temperatures,
said composition is heat and/or light curable, and
said composition is debondable at or about room temperature.

22. A method to reinforce a fragile carrier for the fabrication thereof, said method comprising:
forming an assembly by bringing a substrate and a carrier in direct contact with one another, separated only by a neat aliquot of debondable adhesive composition, a suspension of debondable adhesive in a diluent therefor, or said debondable adhesive is applied to a support therefor; and thereafter
curing the resulting assembly under conditions suitable to promote adhesion therebetween,
wherein said debondable adhesive composition comprises:
one or more bis-maleimide, nadimide or itaconimide oligomer(s);
in the range of about 10 up to 90 wt % of at least one ethylenically unsaturated co-monomer;
optionally a reactive organic diluent, which, when present, is present in the range of about 1 up to 50 wt %;
optionally a non-reactive organic diluent, which, when present, is present in the range of about 5 up to 40 wt %; and
optionally a photoinitiator;
wherein said composition is further characterized by one or more of the following:
said composition is stable to a temperature of at least 200° C.,
said composition is chemically resistant to acids, bases and solvents,
said composition undergoes low level of shrinkage upon curing thereof,
said composition has high adhesion to suitable substrates, especially at elevated temperatures,
said composition is heat and/or light curable, and
said composition is debondable at or about room temperature.

23. The method of claim 22 wherein said fragile carrier is glass, ceramic, stainless steel, a silicon wafer, a polyimide film, or a polyester film.

24. The method of claim 23 wherein said carrier is chemically and/or physically pre-treated to improve the adhesion thereto.

25. The method of claim 23 wherein said fragile carrier has a thickness in the range of about 0.6 up to 1.3 mm.

26. A debondable adhesive composition comprising:
one or more bis-maleimide, nadimide or itaconimide oligomer(s);
in the range of about 10 up to 90 wt % of at least one ethylenically unsaturated co-monomer;
optionally a reactive organic diluent, which, when present, is present in the range of about 1 up to 50 wt %;
optionally a non-reactive organic diluent, which, when present, is present in the range of about 5 up to 40 wt %; and
optionally a photoinitiator;
wherein said composition is further characterized by one or more of the following:
said composition is stable to a temperature of at least 200° C.,
said composition is chemically resistant to acids, bases and solvents,
said composition undergoes low level of shrinkage upon curing thereof,
said composition has high adhesion to suitable substrates, especially at elevated temperatures,
said composition is heat and/or light curable, and
said composition is debondable at or about room temperature.
